(19) United States
(12) Patent Application Publication
(10) Pub. No.: US 2024/0286753 A1
(43) Pub. Date: Aug. 29, 2024

(54) THERMAL MANAGEMENT SYSTEM FOR A BATTERY

(71) Applicant: Rolls-Royce Deutschland Ltd & Co KG, Blankenfelde-Mahlow (DE)

(72) Inventor: Andras LUKACS, Budapest (HU)

(21) Appl. No.: 18/113,235

(22) Filed: Feb. 23, 2023

(51) Int. Cl. B64D 33/08; B60L 58/26; B64D 27/24; H01M 10/613; H01M 10/625; H01M 10/6568; H01M 50/213; H01M 50/227

(52) U.S. Cl. CPC B64D 33/08; B60L 58/26; B64D 27/24; H01M 10/613; H01M 10/625; H01M 10/6568; H01M 50/213; H01M 50/227; B60L 2200/10; B64D 27/026; H01M 2220/20

(57) ABSTRACT

A thermal management system for battery includes a plurality of cells, at least one inlet element having main inlet conduit and a plurality of inlet rail conduits, at least one outlet element having a main outlet conduit and a plurality of outlet rail conduits, and a plurality of battery holders. Each battery holder of the plurality of battery holders includes: a hollow wall structure surrounding a cavity in which a respective cell of the plurality of cells is to be accommodated; an inlet orifice; and an outlet orifice. The thermal management system may further include a coolant configured to be received via the main inlet conduit into a respective inlet rail conduit, wherein the coolant is configured to: circulate through the cavity of the hollow wall structure and exchange heat generated by the respective cell; and flow via a respective outlet rail conduit to the main outlet conduit.

### TECHNICAL FIELD

The present disclosure relates to energy storage systems; more specifically, the present disclosure relates to a thermal management system for a battery including a plurality of cells.

### BACKGROUND

In recent times, electrical propulsion batteries are increasingly used as an electric power source in various industrial and consumer applications. In an example, electrical propulsion batteries are widely used in electric vehicles (EV) and hybrid electric vehicles, such as plug-in hybrid electric (PHEV) vehicles. Such vehicles can be land, marine, or air vehicles, such as electric or hybrid electric aircraft. The EVs may include electrical propulsion batteries as a power source for the operation thereof.

Notably, the electrical propulsion batteries generate heat during operation and therefore need to be cooled in order to provide safe operation thereof. Nowadays, lithium-ion battery cells have been used as the power source for storing energy. This is because lithium-ion batteries offer higher energy per mass and volume features than current battery technologies including nickel-metal hydride, nickel-zinc, or lead-acid battery modules. However, lithium-ion battery cells could perform efficiently only in a narrow range of temperatures. Moreover, lithium-ion battery cells fail to perform efficiently beyond or beneath such a narrow range of temperature. Additionally, in such a case, the energy that is stored in the lithium-ion battery cell is exploited, thereby limiting the power generation therefrom and decreasing the lifetime thereof. Moreover, when lithium-ion battery cells operate at extremely high temperatures, dangerous consequences such as battery deterioration and explosion may result. Furthermore, the present electrical propulsion batteries may be inefficient due to a variety of factors such as resistance in different electrical connections and battery cell imbalance.

Therefore, to ameliorate the technical problems encountered with known electrical propulsion batteries, there exists a need to provide an improved electrical propulsion battery module that is more effective when in operation.

### SUMMARY

The present disclosure seeks to provide an improved thermal management system for a battery including a plurality of cells. The present disclosure seeks to provide a solution to the existing problem by maintaining an optimum temperature of the battery during operation. An aim of the present disclosure is to provide a solution that overcomes, at least partially, the aforementioned problems encountered in prior art, and to provide a thermal management system that improves the energy storage, power performance, and/or lifetime of the battery.

The scope of the present disclosure is defined solely by the appended claims and is not affected to any degree by the statements within this summary. The present embodiments may obviate one or more of the drawbacks or limitations in the related art.

In a first aspect, the present disclosure provides a thermal management system for a battery including a plurality of cells. The thermal management system includes: at least one inlet element including a main inlet conduit and a plurality of inlet rail conduits extending from and fluidically coupled to the main inlet conduit; at least one outlet element including a main outlet conduit and a plurality of outlet rail conduits extending from and fluidically coupled to the main outlet conduit; and a plurality of battery holders. Each battery holder of the plurality of battery holders includes: a hollow wall structure surrounding a cavity in which a given cell is to be accommodated when the thermal management system is in use; an inlet orifice formed in a first portion of the hollow wall structure; and an outlet orifice formed in a second portion of the hollow wall structure. Further, each battery holder of the plurality of battery holders is arranged in a manner such that the inlet orifice is fluidically coupled to a given inlet rail conduit, and the outlet orifice is fluidically coupled to a given outlet rail conduit.

When the thermal management system is in use, a coolant may be received via the main inlet conduit into the given inlet rail conduit, wherefrom the coolant is configured to: flow via the inlet orifice into the cavity of the hollow wall structure; circulate through the cavity of the hollow wall structure for exchanging heat generated by the given cell; exit the cavity of the hollow wall structure via the outlet orifice; and flow via the given outlet rail conduit to the main outlet conduit.

In certain examples, at least one geometrical parameter is associated with the given inlet rail conduit, the given outlet rail conduit, the inlet orifice, the outlet orifice, or a combination thereof. The at least one geometrical parameter may be modified for facilitating a uniform transportation and distribution of the coolant when the thermal management system is in use.

In certain examples, two inlet rail conduits, or each inlet rail conduit, of the plurality of inlet rail conduits, may be arranged substantially parallel to each other. In certain examples, two outlet rail conduits, or each outlet rail conduit, of the plurality of outlet rail conduits, may be arranged substantially parallel to each other. In certain examples, at least one inlet rail conduit (or all inlet rail conduit of the plurality of inlet rail conduits) and at least one outlet rail conduit (or all outlet rail conduit of the plurality of outlet rail conduits) may be arranged substantially parallel to each other. In certain examples, at least one inlet rail conduit (or all inlet rail conduit of the plurality of inlet rail conduits) and at least one outlet rail conduit (or all outlet rail conduit of the plurality of outlet rail conduits) may be arranged adjacent to each other (or with no other conduit in between). In certain examples, the at least one inlet element, the at least one outlet element, and the plurality of battery holders are made of or manufactured using a plastic material that is leakproof.

In certain examples, when the given cell is accommodated in the cavity, the given cell is sealed within the cavity using an O-ring, a bonding material, or a combination thereof.

In certain examples, the at least one inlet element includes a plurality of inlet elements and the at least one outlet element includes a plurality of outlet elements, and the thermal management system further includes a main inlet channel and a main outlet channel fluidically coupled to the plurality of inlet elements and a plurality of outlet elements, respectively.

In a second aspect, the present disclosure provides an aircraft, including an electric propulsion unit, and a thermal management system according to the first aspect. The electric propulsion unit may be a full electric or hybrid electric propulsion unit. In certain examples, the electric propulsion unit may include an electric machine or motor, a power electronics converter, and an energy storage system. The energy storage system may include the thermal management system and/or at least one battery.

Embodiments of the present disclosure may advantageously eliminate, reduce, or at least partially address the aforementioned problems in the prior art and provide a thermal management system that employs a coolant for maintaining an optimum temperature of the battery when in use.

Additional aspects, advantages, features, and objects of the present disclosure become apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIG. 1 is a schematic illustration of a thermal management system for a battery including a plurality of cells, in accordance with an embodiment of the present disclosure;

FIGS. 2A, 2B, 2C, and 2D are views of a thermal management system, in accordance with an embodiment of the present disclosure;

FIG. 3 is a cross-sectional view of a thermal management system, in accordance with an embodiment of the present disclosure;

FIG. 4 is a perspective view of a thermal management system, in accordance with an embodiment of the present disclosure; and

FIG. 5 is a schematic view of an aircraft in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In overview, embodiments of the present disclosure are concerned with a thermal management system for a battery including a plurality of cells.

Throughout the present disclosure, the thermal management system may refer to an arrangement that is used for managing or dissipating heat generated during electrochemical processes occurring in the cells of a battery. The thermal management system includes at least one inlet element, at least one outlet element, and a plurality of battery holders operatively and fluidically coupled with each other for allowing the flow of a coolant therethrough. Moreover, each battery holder includes a hollow wall structure for providing direct cooling to a plurality of cells of the battery. The direct cooling increases the battery lifetime and also provides safe operation thereof, thereby preventing a thermal runaway. Furthermore, the thermal management system employs a coolant in order to provide an optimum temperature to the battery. It will be appreciated that when the battery operates under optimum temperature then the energy and/or power performance of the battery is increased.

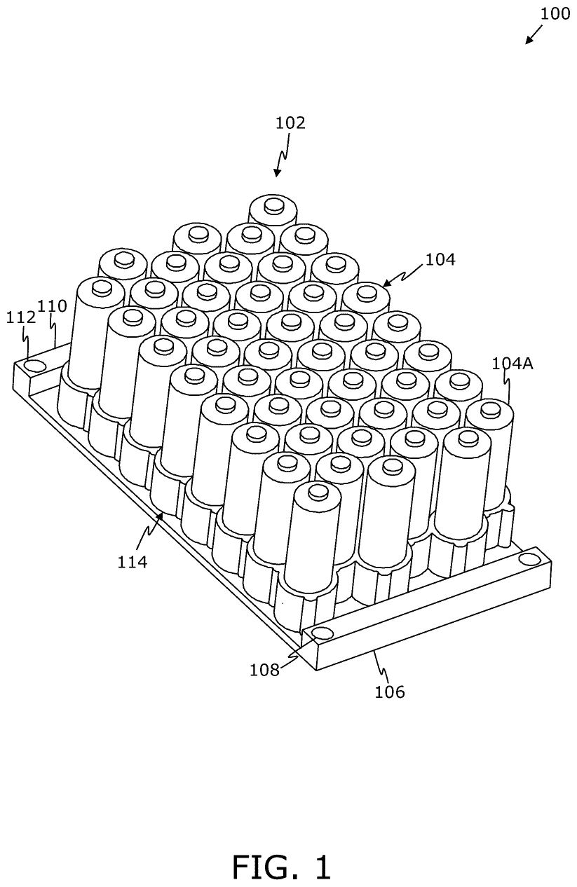

FIG. 1 is a schematic illustration of a thermal management system 100 for a battery 102 including a plurality of cells 104, in accordance with an embodiment of the present disclosure. The battery 102 refers to a source of electric power. As shown, the thermal management system 100 includes at least one inlet element 106. The at least one inlet element 106 may refer to a network of pipes that are fluidically coupled with each other to allow the flow of a fluid through them. The at least one inlet element includes a main inlet conduit 108 and a plurality of inlet rail conduits (not shown). The main inlet conduit 108 may refer to a conduit from where the fluid enters first and foremost into the system 100.

The thermal management system 100 includes at least one outlet element 110. The at least one outlet element 110 may refer to a network of pipes or the like conduits that are fluidically coupled with each other to allow the flow of a fluid through them. The at least one outlet element 110 includes a main outlet conduit 112 and a plurality of outlet rail conduits (not shown). The main outlet conduit 112 may refer to a conduit from where the fluid exits from the thermal management system 100.

The thermal management system 100 includes a plurality of battery holders 114 for accommodating a given cell 104A therein when the thermal management system 100 is in use. The battery holder 114 may refer to one or more compartments or chambers that are configured for holding the battery 102 in place safely and securely.

As shown, the thermal management system 100, when in use, is configured to receive a coolant (not shown). The coolant may refer to a substance, (e.g., a liquid), that is used to reduce or regulate the temperature of the thermal management system 100. Optionally, the coolant is a dielectric coolant to avoid electrical shortcut hazards. It will be appreciated that when the thermal management system 100 is in use, a coolant is configured to be received via the main inlet conduit 108 into a given inlet rail conduit (not shown), wherefrom the coolant flows via the plurality of battery holders 114 for exchanging heat generated by the given cells 104. Then, the coolant flows via the given outlet rail conduit to the main outlet conduit 112. Optionally, the thermal management system 100 further includes a coolant reservoir and/or a pump for delivering the coolant, (e.g., from the coolant reservoir), to the main inlet conduit 108.

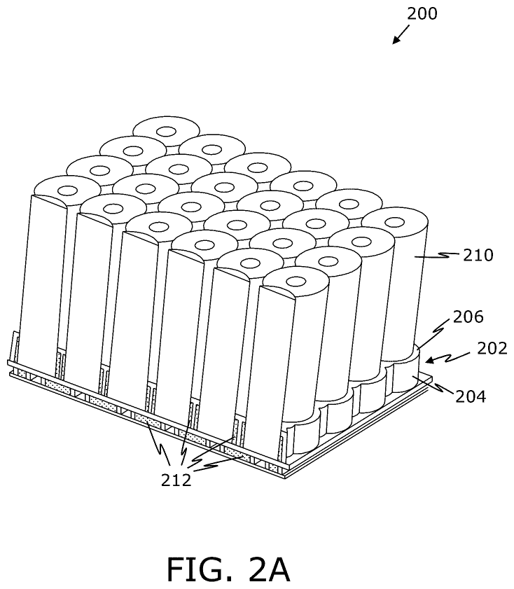

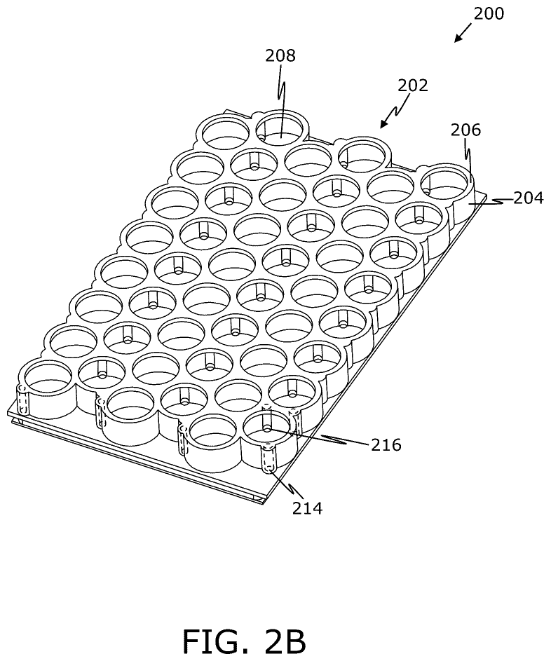

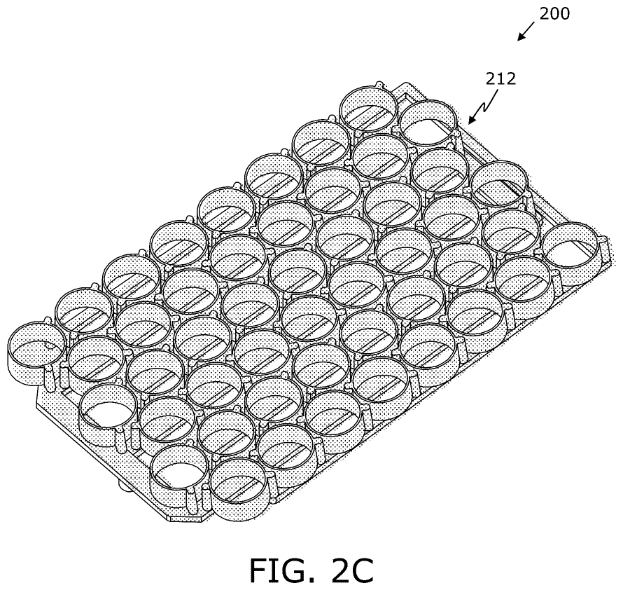

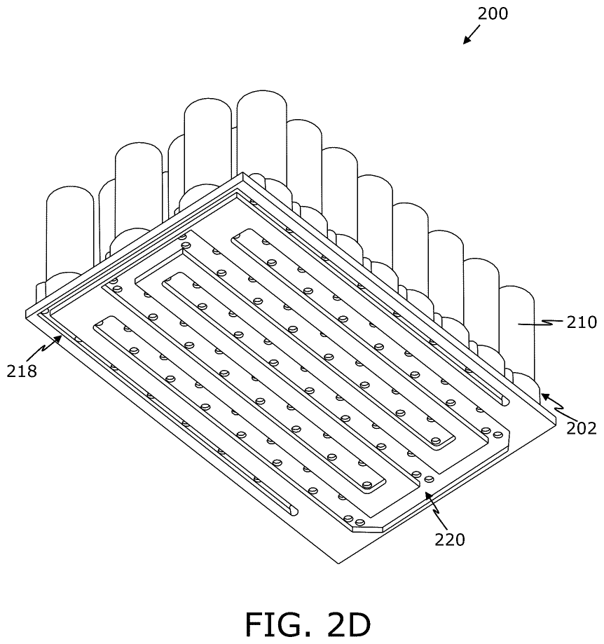

FIGS. 2A, 2B, 2C, and 2D are views of a thermal management system 200, in accordance with an embodiment of the present disclosure. As shown in FIG. 2A, a cross-sectional view of the thermal management system 200. The thermal management system 200 includes a plurality of battery holders 202. As shown, each battery holder such as 204 includes a hollow wall structure 206 surrounding a cavity 208 (as depicted in FIG. 2B) in which a given cell 210 is to be accommodated when the thermal management system 200 is in use. Moreover, the thermal management system 200 receives a coolant 212 (depicted using a dotted pattern) in such a manner that the coolant 212 surrounds the given cell 210 for exchanging heat generated by the given cell 210. It will be appreciated that the coolant 212 supports direct cooling of the given cell 210. In particular, the space for the coolant 212 around one cell 210 may be constrained by the hollow wall structure 206 on an outer radial side and the cell 210 itself on an inner radial side.

As shown in FIG. 2B, the plurality of battery holders 202 is visible, that is functioning as a cooling jacket. Moreover, each battery holder such as 204 includes an inlet orifice 214 formed in a first portion of the hollow wall structure 206. Moreover, each battery holder such as 204 includes an outlet orifice 216 formed in a second portion of the hollow wall structure 206. It will be appreciated that each battery holder such as 204 is arranged in a manner that the inlet orifice 214 is fluidically coupled to a given inlet rail conduit (not shown), and the outlet orifice 216 is fluidically coupled to a given outlet rail conduit (not shown). Optionally, the first portion and the second portion are opposite to each other, such that the first portion lies towards the given inlet rail conduit, while the second portion lies towards the given outlet rail conduit.

When the thermal management system 200 is in use, the coolant 212 is configured to be received via a main inlet conduit (not shown) into the given inlet rail conduit, wherefrom the coolant 212 flows via the inlet orifice 214 into the cavity 208 of the hollow wall structure 206, the coolant 212 circulates through the cavity 208 of the hollow wall structure 206 for exchanging heat generated by the given cell 210 (as depicted in FIG. 2A), the coolant 212 exits the cavity 208 of the hollow wall structure 206 via the outlet orifice 216, and the coolant 212 flows via the given outlet rail conduit to the main outlet conduit. In certain examples, the coolant 212 may flow through at least one inlet element 218 (as depicted in FIG. 2D) until the coolant 212 flows out on the outlet orifice 216. In some examples, in the meantime, the coolant 212 may directly contact the given cell 210 and take up the excessive heat therefrom.

In FIG. 2C, the coolant 212 circulating in the thermal management system 200 is shown. Herein, the coolant 212 (depicted as a dotted pattern hatching) is entering into a main inlet conduit of the at least one inlet element 218. The main inlet conduit is fluidically coupled to a plurality of inlet rail conduits that extends therefrom. Moreover, after entering into the plurality of inlet rail conduits, the coolant 212 flows via the inlet orifice 214 into the cavity 208 of the hollow wall structure 206, the coolant 212 then circulates through the cavity 208 of the hollow wall structure 206 for exchanging heat generated by the given cell 210, and the coolant 212 exits the cavity 208 of the hollow wall structure 206 via the outlet orifice 216, and the coolant 212 flows via the given outlet rail conduit to the main outlet conduit.

A bottom perspective view of the thermal management system 200 is shown in FIG. 2D. Herein, the thermal management system 200 includes the at least one inlet element 218 and the at least one outlet element 220 for allowing the coolant 212 to flow therethrough. In certain examples, the at least one inlet element 218 and the at least one outlet element 220 may act or be configured as channels that allow the flow of the coolant therethrough.

In some examples, the at least one inlet element 218, the at least one outlet element 220, and the plurality of battery holders such as 202 are made of or manufactured using a plastic material that is leakproof. In certain examples, the at least one inlet element 218, the at least one outlet element 220, and the plurality of battery holders such as 202 are made as one integral object, e.g., molded and/or welded using one material. The plastic material may be a thermosetting polymer material. In some examples, the thermosetting polymer may be a permanent setting polymer that gets hardened and sets during molding process thereof and cannot be softened again. Examples of the thermosetting polymers include Bakelite, vulcanized rubbers, epoxy resin, vinyl ester resin, polyurethane, and so forth. Beneficially, the thermosetting polymers are non-toxic in nature. In some examples, the aforementioned components of the thermal management system 200 made from or fabricated using the plastic material may be fixed together in order to form a closed coolant cavity 208 without any leakage. In certain examples, a plurality of manufacturing techniques such as a bonding process may be used for the fabrication of the thermal management system 200. In some examples, one or more welding techniques such as a friction plastic welding, a laser welding, or so forth may be used in the fabrication of the thermal management system 200.

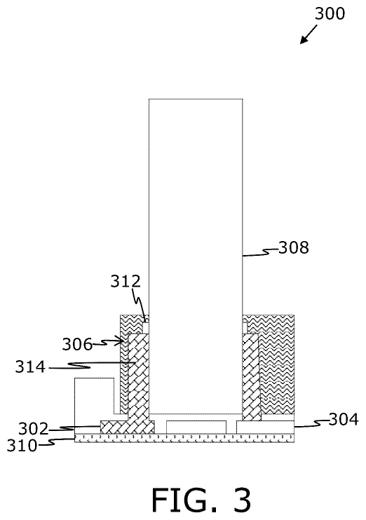

FIG. 3 is a cross-sectional view of a thermal management system 300, in accordance with an embodiment of the present disclosure. As shown, the thermal management system 300 includes a given inlet rail conduit 302, a given outlet rail conduit 304, and a hollow wall structure 306 for accommodating a given cell 308 therein. The hollow wall structure 306 is configured to constrain a space for a coolant 314 surrounding and flowing around the cell 308. In certain examples, the thermal management system 300 may include a cover 310 at the bottom thereof. It will be appreciated that the thermal management system 300 supports the optimization of at least one geometrical parameter of the given inlet rail conduit 302, the given outlet rail conduit 304, the inlet orifice (not shown), and the outlet orifice (not shown). In some examples, the at least one geometrical parameter may include a length, a diameter, a shape, a cross-section, or a combination thereof. In some examples, the at least one geometrical parameter is optimized for providing an efficient and improved thermal management by the thermal management system 300.

In certain examples, at least one geometrical parameter is associated with the given inlet rail conduit 302, the given outlet rail conduit 304, the inlet orifice, the outlet orifice, or a combination thereof. The at least one geometrical parameter may be modified for facilitating a uniform transportation and distribution of a coolant 314 when the thermal management system 300 is in use. In certain examples, a diameter of the inlet orifice is greater than a diameter of the outlet orifice. In such a case, the coolant 314 in the cavity of the hollow wall structure 306 would be circulated (namely, distributed) more uniformly, as a rate at which the coolant enters the cavity of the hollow wall structure 306 would be greater than a rate at which the coolant leaves the cavity of the hollow wall structure 306. In some examples, with further optimization of the at least one geometrical parameter, an even flow distribution of the coolant could be achieved among the plurality of cells thus making it possible to minimize the temperature difference between the plurality of cells.

In certain examples, when the given cell 308 is accommodated in the cavity (not shown), the given cell 308 is sealed within the cavity using any one of: an O-ring 312 a bonding material. The O-ring 312 refers to a packing or a mechanical gasket in the shape of a torus and that surrounds the given cell. In other words, the O-ring 312 is a loop of elastomer with a round cross-section, designed to be seated in the cavity and compressed during assembly between two or more components and forming a seal at the interface. Beneficially, the O-ring 312 provides that a circumferential area of the given cell 308 is accurately sealed in order to provide effective contact between the coolant 312 and the given cell 308. Optionally, the bonding material is used for providing a seal-tight cavity. In certain examples, the bonding material may include a metal, a resin, concrete, a polycarbonate, a ceramic, or a combination thereof.

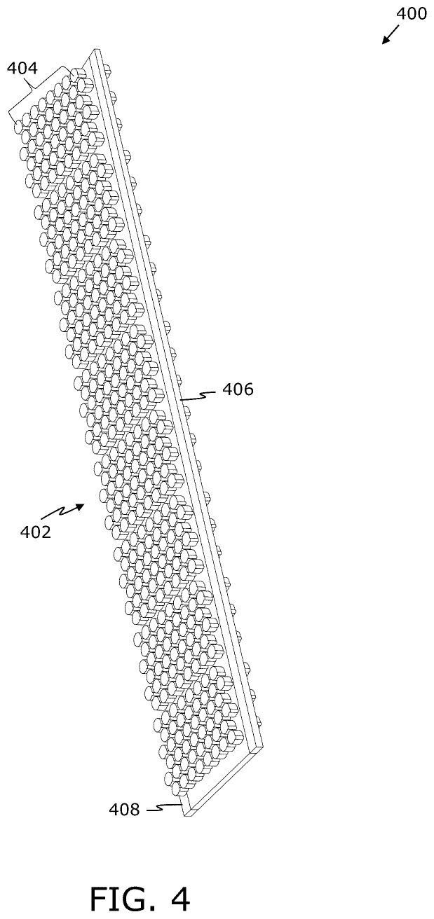

FIG. 4 is a perspective view of a thermal management system 400 for a battery 402 including a plurality of cells 404, in accordance with an embodiment of the present disclosure. As shown, the thermal management system 400 includes at least one inlet element (not shown) and at least one outlet element (not shown). Herein, the at least one inlet element includes a plurality of inlet elements (not shown) and the at least one outlet element includes a plurality of outlet elements (not shown). Moreover, the thermal management system 400 further includes a main inlet channel 406 fluidically coupled to the plurality of inlet elements and a main outlet channel 408 fluidically coupled to the plurality of outlet elements. In an example implementation, the plurality of inlet elements, the plurality of outlet elements, and the plurality of battery holders are arranged in form of a one-dimensional (1D) array. In some cases, the shown one-dimensional array may be stacked together to build larger modules of the system 400. In certain examples, a plurality of additional channels (such as one on the inlet side and one on the outlet side) are formed in the thermal management system 400.

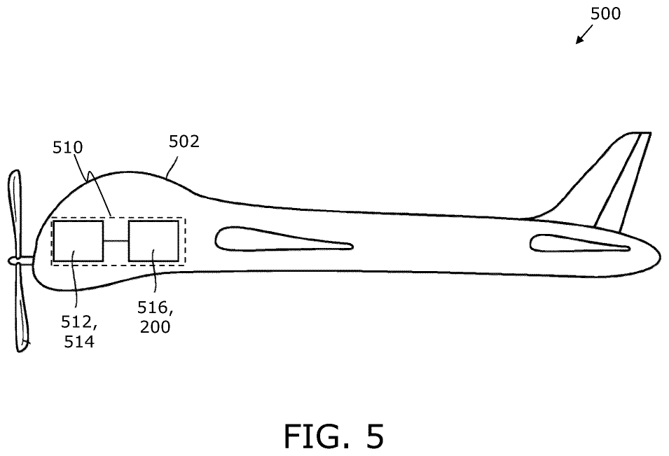

FIG. 5 is a schematic view of an aircraft 500 in accordance with an embodiment of the present disclosure. The aircraft 500 is an electric aircraft with an airframe 502, and has an electric propulsion unit 510, including an electric machine 512, a power electronics converter 514, and an energy storage system 516. The energy storage system 516 includes a thermal management system, such as the thermal management system 200 or any other thermal management system according to the present disclosure.

Modifications to embodiments of the present disclosure described in the foregoing are possible without departing from the scope of the present disclosure as defined by the accompanying claims. Expressions such as “including,” “comprising,” “incorporating,” “have,” or “is” used to describe and claim the present disclosure are intended to be construed in a non-exclusive manner, namely allowing for items, components or elements not explicitly described also to be present. Reference to the singular is also to be construed to relate to the plural.

It is to be understood that the elements and features recited in the appended claims may be combined in different ways to produce new claims that likewise fall within the scope of the present disclosure. Thus, whereas the dependent claims appended below depend on only a single independent or dependent claim, it is to be understood that these dependent claims may, alternatively, be made to depend in the alternative from any preceding or following claim, whether independent or dependent, and that such new combinations are to be understood as forming a part of the present specification.

While the present disclosure has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A thermal management system for a battery comprising a plurality of cells, the thermal management system comprising:
at least one inlet element having a main inlet conduit and a plurality of inlet rail conduits extending from and fluidically coupled to the main inlet conduit;
at least one outlet element having a main outlet conduit and a plurality of outlet rail conduits extending from and fluidically coupled to the main outlet conduit; and
a plurality of battery holders, wherein each battery holder of the plurality of battery holders comprises:
a hollow wall structure surrounding a cavity in which a respective cell of the plurality of cells is configured to be accommodated when the thermal management system is in use;
an inlet orifice formed in a first portion of the hollow wall structure; and
an outlet orifice formed in a second portion of the hollow wall structure,
wherein each battery holder of the plurality of battery holders is arranged in a manner that the inlet orifice is fluidically coupled to a respective inlet rail conduit of the plurality of inlet rail conduits, and the outlet orifice is fluidically coupled to a respective outlet rail conduit of the plurality of outlet rail conduits.

2. The thermal management system of claim 1, wherein at least one geometrical parameter is associated with the respective inlet rail conduit of the plurality of inlet rail conduits, the respective outlet rail conduit of the plurality of outlet rail conduits, the inlet orifice, the outlet orifice, or a combination thereof,
wherein the at least one geometrical parameter is configured to be modified for facilitating a uniform transportation and distribution of a coolant when the thermal management system is in use.

3. The thermal management system of claim 2, wherein the at least one inlet element, the at least one outlet element, and the plurality of battery holders each comprise a plastic material that is leakproof.

4. The thermal management system of claim 3, wherein the respective cell of the plurality of cells is accommodated within the cavity and sealed within the cavity with an O-ring, a bonding material, or a combination thereof.

5. The thermal management system of claim 4, wherein the at least one inlet element comprises a plurality of inlet elements,
wherein the at least one outlet element comprises a plurality of outlet elements, and
wherein the thermal management system further comprises a main inlet channel coupled to the plurality of inlet elements and a main outlet channel coupled the plurality of outlet elements.

6. The thermal management system of claim 1, wherein the at least one inlet element, the at least one outlet element, and the plurality of battery holders each comprise a plastic material that is leakproof.

7. The thermal management system of claim 1, wherein the respective cell of the plurality of cells is accommodated within the cavity and sealed within the cavity with an O-ring, a bonding material, or a combination thereof.

8. The thermal management system of claim 1, wherein the at least one inlet element comprises a plurality of inlet elements,
wherein the at least one outlet element comprises a plurality of outlet elements, and
wherein the thermal management system further comprises a main inlet channel coupled to the plurality of inlet elements and a main outlet channel coupled the plurality of outlet elements.

9. An aircraft comprising:
an electric propulsion unit having a thermal management system for a plurality of cells,
wherein the thermal management system comprises:
at least one inlet element having a main inlet conduit and a plurality of inlet rail conduits extending from and fluidically coupled to the main inlet conduit;
at least one outlet element having a main outlet conduit and a plurality of outlet rail conduits extending from and fluidically coupled to the main outlet conduit; and
a plurality of battery holders, wherein each battery holder of the plurality of battery holders comprises:
a hollow wall structure surrounding a cavity in which a respective cell of the plurality of cells is configured to be accommodated when the thermal management system is in use;
an inlet orifice formed in a first portion of the hollow wall structure; and
an outlet orifice formed in a second portion of the hollow wall structure,
wherein each battery holder of the plurality of battery holders is arranged in a manner that the inlet orifice is fluidically coupled to a respective inlet rail conduit of the plurality of inlet rail conduits, and the outlet orifice is fluidically coupled to a respective outlet rail conduit of the plurality of outlet rail conduits.

10. The aircraft of claim 9, wherein at least one geometrical parameter is associated with the respective inlet rail conduit of the plurality of inlet rail conduits, the respective outlet rail conduit of the plurality of outlet rail conduits, the inlet orifice, the outlet orifice, or a combination thereof,
wherein the at least one geometrical parameter is configured to be modified for facilitating a uniform transportation and distribution of a coolant when the thermal management system is in use.

11. The aircraft of claim 10, wherein the at least one inlet element, the at least one outlet element, and the plurality of battery holders each comprise a plastic material that is leakproof.

12. The aircraft of claim 11, wherein the respective cell of the plurality of cells is accommodated within the cavity and sealed within the cavity with an O-ring, a bonding material, or a combination thereof.

13. The aircraft of claim 12, wherein the at least one inlet element comprises a plurality of inlet elements,
wherein the at least one outlet element comprises a plurality of outlet elements, and
wherein the thermal management system further comprises a main inlet channel coupled to the plurality of inlet elements and a main outlet channel coupled the plurality of outlet elements.

14. The aircraft of claim 9, wherein the at least one inlet element, the at least one outlet element, and the plurality of battery holders each comprise a plastic material that is leakproof.

15. The aircraft of claim 9, wherein the respective cell of the plurality of cells is accommodated within the cavity and sealed within the cavity with an O-ring, a bonding material, or a combination thereof.

16. The aircraft of claim 9, wherein the at least one inlet element comprises a plurality of inlet elements,
wherein the at least one outlet element comprises a plurality of outlet elements, and
wherein the thermal management system further comprises a main inlet channel coupled to the plurality of inlet elements and a main outlet channel coupled the plurality of outlet elements.

17. The aircraft of claim 9, wherein the electric propulsion unit is a full electric propulsion unit or a hybrid electric propulsion unit.

18. The aircraft of claim 9, wherein the electric propulsion unit further comprises an electric machine or motor, a power electronics converter, and an energy storage system, and
wherein the energy storage system comprises the thermal management system.
